(19) United States
(12) Patent Application Publication
(10) Pub. No.: US 2012/0027344 A1
(43) Pub. Date: Feb. 2, 2012

(54) LIGHT GUIDING BEND WITH CURVED SLITS

(75) Inventors: Marcellinus Petrus Carolus Michael Krijn, Eindhoven (NL); Bart Andre Salters, Eindhoven (NL)

(73) Assignee: KONINKLIJKE PHILIPS ELECTRONICS N.V., EINDHOVEN (NL)

(21) Appl. No.: 13/262,930

(22) PCT Filed: Apr. 6, 2010
(86) PCT No.: PCT/IB2010/051474

§ 371 Date: Oct. 5, 2011

(30) Foreign Application Priority Data
Apr. 10, 2009 (EP) 09157809.6

(51) Int. Cl. G02B 6/26; G02B 6/125

(52) U.S. Cl. 385/32; 264/1.24

(57) ABSTRACT

A light guide (102) for bending guided light from a first direction (12) into a second direction (13) using a set of curved slits (9, 10, 11) formed in the light guiding core. The set of curved slits delimits separate bent light guide channels (14, 15, 16, 17) which guide the light through the bent light guide channels by total internal reflection.

### FIELD OF THE INVENTION

The present invention relates to the field of light guiding, and more specifically to a light guide with reduced light losses.

### BACKGROUND OF THE INVENTION

Light guides are used in many lighting applications, such as for general lighting purpose as well as backlight sources for Liquid Crystal Display (LCD) or TV screens.

This type of construction is generally used for back-light illumination of, e.g. LCD monitors, where a source of light is connected to one side of the light guide plate and the light is reflected towards the LCD, by means of reflecting structures.

Another possible application in which light guides can be used is for example background lightning for television sets, such as flat screen display panel. Light effects generated around a display panel may be guided from a single point source, for example an LED or a laser beam, over the perimeter of the display panel. In this way a large area can be illuminated by using a limited amount of light sources providing at the same time more pleasant viewing experiences for viewers, e.g. comparable to the Philips Ambilight system.

JP 2007087725 describes a light guide body comprising a slit to reflect part of the guided light from one face of the light guide body, in the direction of a shadow site produced by a hole, to an opposite side of the light guide body. This construction is used to guide light around an object, such as an illumination around a round switch.

However, efficient internal reflections of the light guided at the slit surface occurs only at small angles, and hence efficient light reflection over sharp corners is not achievable with such a system as most of the light is lost by refraction.

### SUMMARY OF THE INVENTION

Hence, an improved light guide which with reduced light losses is able to transport light over sharp corners would be advantageous and in particular an improved light guide which is able to transport light along the rim of a screen using a limited amount of light sources would be advantageous.

Furthermore an improved screen where light is continuously and uniformly diffused around its rim using a light guide which employs a minimum amount of light sources would be advantageous.

Accordingly, the invention preferably seeks to mitigate, alleviate or eliminate one or more of the above mentioned disadvantages singly or in any combination. To this end, the present invention provides a light guide that solves the above mentioned problems of the prior art by introducing curved slits in a light guide substrate. These curved slits delimit separate bent light guide channels which are able to guide the light through the bent channels by total internal reflection.

The invention is particularly, but not exclusively, advantageous for obtaining an improved light weight, low cost, light guide which is able to bend sharply guided light, e.g. around 90° corners or in a bent light guide. This light guide may be used as a component for background lighting of monitors, e.g. Philips Ambilight TV, allowing diffusion of light around the whole rim of a monitor with a limited amount of light sources.

A first aspect of the invention provides a light guide for bending guided light from a first direction into a second direction comprising light guide for bending guided light from a first direction into a second direction comprising: i) a substrate forming a light guiding core of the light guide; ii) one or more curved slits formed in the light guiding core, each with a first end pointing towards said first direction and with a second end pointing towards said second direction. The one or more curved slits are arranged to delimit separate bent light guide channels for guiding the light through the bent light guide channels by total internal reflection.

In the present context, having the ends of the slits pointing towards the propagating light means that they point towards the general direction of the propagating light. Deviations smaller than the critical angle would typically still provide an efficient bending and are considered within the scope of pointing towards.

Total internal reflection (TIR) is an optical phenomenon which permits light confinement in light guiding cores. It occurs when light strikes a medium boundary at an angle larger than the critical angle with respect to the normal to the boundary surface. If the refractive index is lower on the other side of the boundary no light can pass through, so effectively all of the light is reflected. The critical angle is the angle of incidence at which light is refracted such that it travels along the boundary.

Generally, many light guides, such as most optical fibers, transmit light by TIR. Light guides, among other components, consist of a most internal part, the core and an outer part, the cladding, which surrounds the core. The light bounces along in the core by TIR as the refractive index of the core is greater than the one of the cladding. In the present invention, the light guide core preferably has a rectangular cross section. Other light guide cores having circular or triangular cross sections could also be advantageous.

A bent light guide channel (hereafter also referred to simply as channel) may be formed between two curved slits (hereafter also referred to simply as slits) and also between a curved slit and the edge of the waveguide core. Particularly for bent section of the light guide, the inner/outer edge of the core may be used to form a channel together with a curved slit. The number of channels can thereby be larger or smaller than the number of slits depending on whether they are positioned in a bent section of the light guide or not.

While low or no light losses occur in light guides that transmit light along straight direction of propagation, in bent light guides the guided light is at least partially lost by means of refraction. This occurs when light strikes at the boundary core/cladding with an angle smaller then the critical angle with respect to the normal to the surface boundary. The positioning of the curved slits in the bending part of the light guide substrate core provides multiple boundaries (core/slit) with different inclinations, which allows a larger amount of light beams that enters the light guide to travel down the light guide without leaking out. In some embodiments, a section of the light guiding core is bent and the one or more slits are positioned in this bent section of the light guiding core. When slits are positioned in a bent part of the light guide core, they are preferably designed so that each delimited channel follows the bending radius of the bend at the position of each channel. In the embodiments where the light guide is partially bent a bending radius of the light guide core is larger than the widths of said bent light guide channel.

In other embodiments the width of each bent light guide channel is smaller than a bending radius of the bent light guide channel.

The design of the slits and channels, and possible optimizations of these will be described later in relations to FIGS. 7a and b.

The presence of curved slits in a light guide described by the first aspect of the invention allows for confinement of light, i.e. TIR, in bent light guides where the light is bent between two directions, e.g. perpendicular to each other. The shape of the slits may be tapered and preferably pointed at the ends pointing towards at least the first direction of propagation. The more blunt an end of a slit is, the more light will be incident at this end under either non-TIR angles or at angles deflecting the light to strike the light guide wall under non-TIR angles, both cases leading to losses. Tapering of the ends on slits pointing towards the direction from which the light comes (the first direction of propagation), will thereby reduce the area of the slits as seen by the propagating light and thereby reduce unintended scattering of light by the ends of the slits.

In same embodiments the separate bent light guide channels, delimited by the one or more slits, have a width adjusted to allow for bending of incident light from said first direction into said second direction with minimized light loss.

Light travelling along light guide cores generally bounces along the core boundary. Only the light rays that enter the light guide core within a certain range of angles, i.e. the angles which in turn allows the light ray to strike the core boundary with an angle greater than the critical angle, can travel down the light guide without losses. This range of angles is called the acceptance cone of the light guide. In some embodiments the light loss is minimized as the curved slits present in the light guide core provides multiple boundaries (core/slit) with different inclinations. These allow a large amount of light rays that enter the light guide to travel down the light guide without leaking out. In other terms the light loss is minimized by virtually enlarging the acceptance cone of the light guide.

The number of the curved slits (and thereby number of channels), their shape, and the width of the channels as a function of the specific size requirements of the light guide, and a function of the light source properties, such as angular extent and intensity distribution, may be optimized by, for example computer simulation or experimentally, for example by trial and error.

In other embodiments according to the first aspect of the invention the one or more curved slits are filled by a material with a refractive index lower than the refractive index of the light guide substrate.

In some other embodiments according to the first aspect of the invention the one or more curved slits are filled by air.

The refractive index of a medium is a measure for how much the speed of light is reduced inside the medium.

For example high-transparency glass or polymers, such as poly-methyl meta acrilate (PMMA), used in light guides have a standard refractive index around 1.5, which means that in these materials light travels at 1/1.5 times the speed of light in vacuum. Air has a refractive index around 1. Therefore in a PMMA light guide slits filled by air allow for TIR when light strikes at the slits boundary with an angle larger than the critical angle with respect to the normal to the boundary surface, as the refractive index of air is lower than the one of PMMA.

In some embodiments several light guides may be glued to each other using a glue with a refractive index lower than the one of the materials in which the light guides are made so that TIR occurs at the boundary between the glue and the light guide.

Generally the critical angle in lightguide depends on both the material of the lightguide, as well as on the material surrounding it, e.g. air, glue, cladding or glass type.

In other embodiments the one or more curved slits are extending all the way through the thickness of the light guiding core.

A second aspect of the invention provides a device for bending light from a first direction into a second direction comprising: i) a light guide according to first aspect of the invention and ii) a source of light, the source of light being arranged to couple light into the light guide.

The invention in a third aspect relates to a method for bending light from a first direction into a second direction, comprising the steps of: i) providing a light guide and ii) forming one or more curved slits into the light guide so that incident light is bent from said first direction into said second direction by total internal reflection in separate bent light guide channels delimited by said one or more curved slits.

The first, second and third aspect of the present invention may each be combined with any of the other aspects.

The basic idea of the invention can be formulated as to provide a light guide system which minimizes light losses when light is being guided in bending light guides.

These and other aspects of the invention will be apparent from and elucidated with reference to the embodiments described hereinafter.

### BRIEF DESCRIPTION OF THE FIGURES

The present invention will now be explained, by way of example only, with reference to the accompanying Figures, where

FIG. 1 shows the internal reflection of a light guide core, such as an optical fiber core.

FIG. 2 shows a curved light guide core where most of the light is lost in the bend.

FIGS. 3a and 3b show schematic drawings of a light guide core according to one embodiment of the invention.

FIG. 4 is a flow-chart of a method according to an embodiment of the invention.

FIG. 5 is a schematic drawing of the device according to one embodiment of the invention.

FIG. 6 is a schematic diagram showing a beam splitter according to an embodiment of the invention.

FIGS. 7a and b are schematic diagrams illustrating optimization parameters of the light guide according to one embodiment of the invention.

### DETAILED DESCRIPTION OF EMBODIMENTS

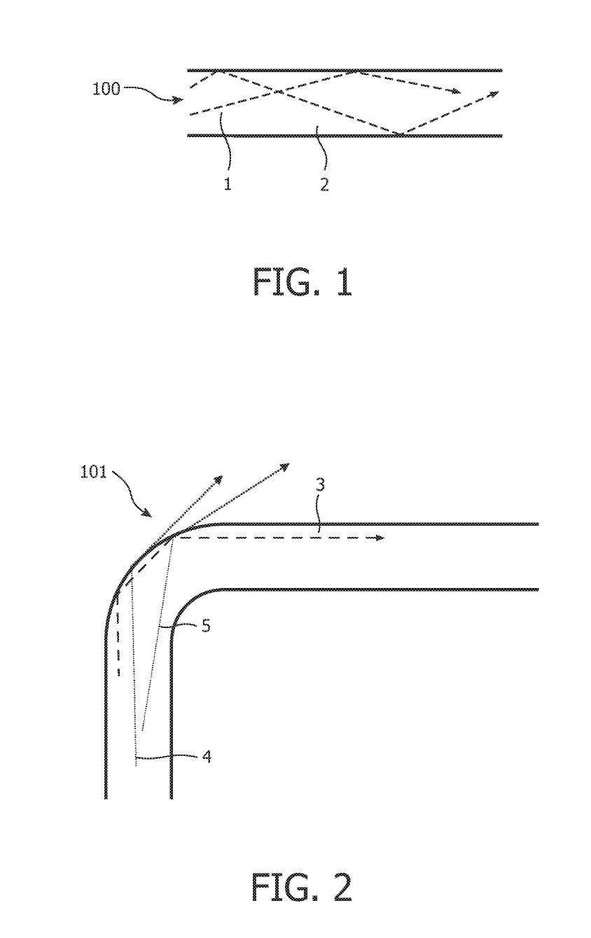

FIG. 1 is a schematic drawing representing the light path of a light ray which is guided in a light guide core, such as an optical fiber core. In general when a light ray hits a boundary between materials with different refractive indices, it is partially refracted at the boundary surface, and partially reflected. FIG. 1 shows a light guide core 100 where light ray 1 and 2 hit the light guide core boundaries with an angle of incidence which is greater (i.e. the ray is closer to being parallel to the boundary) than the critical angle for the boundary. As shown in FIG. 1 the light rays 1 and 2, as their angle of incidence is above the critical angle, experience total internal reflection so that effectively all the light of light rays 1 and 2 is reflected internally.

This is normally not the case when the light guide is bent as shown by FIG. 2. In a bent light guide 101 light ray 3, which hits the light guide core boundary with an angle of incidence above the critical angle, experiences total internal reflection, while light beams 4 and 5 which strikes at an angle larger than the critical angle with respect to the normal, experience partial reflection and refraction. A bend in a light guide core causes therefore a loss of light at the core boundary as part of the light is refracted outside the light guide core. This is true in particular, as shown by FIG. 2, when a bend in a light guide core is very sharp, e.g. 90° or even larger.

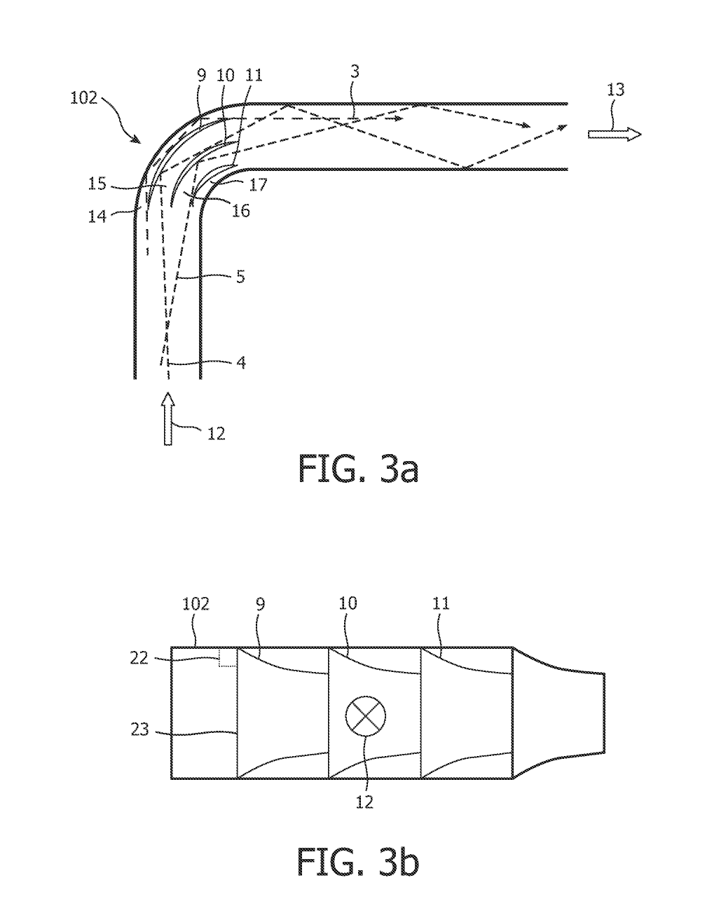

FIG. 3a shows a schematic drawing of a light guide core according to one embodiment of the invention. As shown in FIG. 3a the light guide core 102 can bend guided light from a first direction 12 into a second direction 13 with minimized light losses. The presence of a set of curved slits 9, 10 and 11 formed in the light guiding core of the light guide 102, delimits four channels 14, 15, 16 and 17 formed between slits and between slits and light guide core boundaries. The light passing through these channels may behave as if it was guided in separate light guide cores. Some light beams, such as light beams 4 and 5 in FIG. 2, have angles of incidence to the boundary of the light guide core which would not allow total internal reflection and therefore would be partially lost. In the light guide core 102, these angles of incidence are modified by the presence of the curved slits 9, 10 and 11. Indeed in FIG. 3a the light beams 4 and 5 hit the curved slits 9, 10 and 11 with an angle that is larger than the critical angle for the boundary light guide core/slits. Thereby light beams 4 and 5, which would be partially lost in a convential bend light guide, experience TIR in the light guide core 102.

In FIG. 3a the number of curved slits and channels was reduced to 3 and 4 respectively only for simplicity reasons. The number of the curved slits and the width of the channels depending on specific size requirements of the light guide maybe optimized by, for example, computer simulation or experimentally, for example by trial and error.

FIG. 3b shows a 3-dimensional end/view of the light guide 102 of FIG. 3a wherein preferred design parameters of slits 9/11 are illustrated. As can be seen the slits extends all the way through the core 102.

Further, the ends 23 of the slits pointing towards the first direction of propagation 12 are pointed in that the slits are very narrow or tapered towards this end. Thereby, the ends 23 are very thin, as represented by a line in FIG. 3b.

Further, the slits are formed so that their side facets are normal to a plane of their curvature. In the example of bent light guide core 102, the plane of the curvature of the slits is identical to the top or bottom surface of the core. Hence, the angle 22 between a side facet of the slits and the top of the core is preferably normal. This ensures that reflections on the side facets of the slits is kept in the plane of the bend and no out of plane reflections leading to losses is caused by the slits.

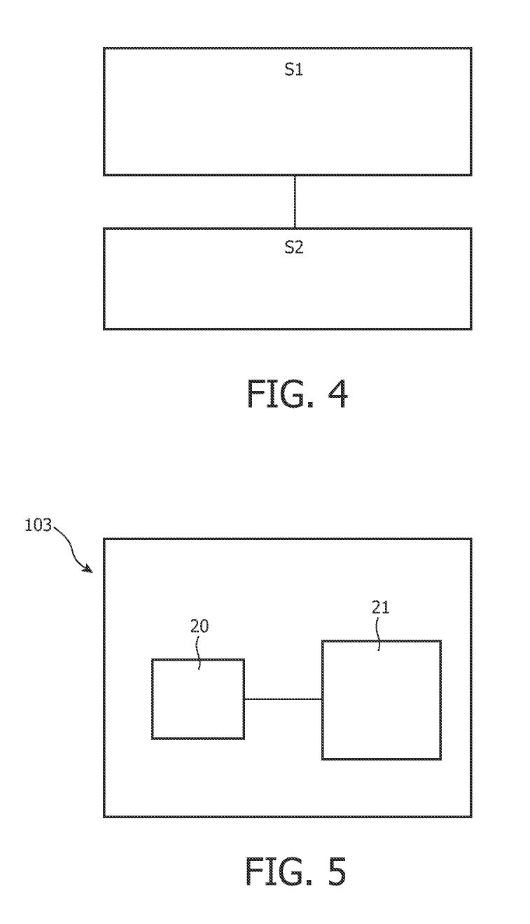

FIG. 4 is a flow-chart of a method for bending light from a first direction into a second direction comprising the steps S1 providing a substrate for a light guide and S2 forming one or more curved slits into the substrate so that incident light is bent from said first direction into said second direction by total internal reflection in separate bent light guide channels delimited by said one or more curved slits.

FIG. 5 is a schematic drawing of the device according to one embodiment of the invention. The device 103 comprises a source of light 20 functionally connected to a light guide substrate 21. Examples of source of lights may be monochromatic or polychromatic sources, such as Light Emitting Diodes, LEDs, or lasers.

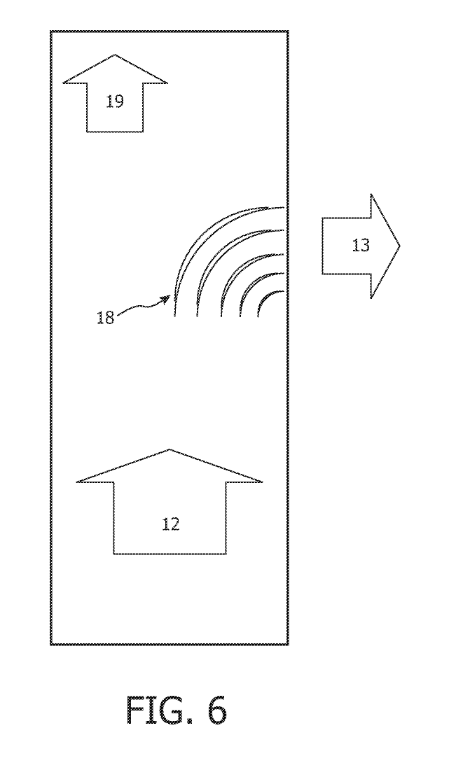

FIG. 6 illustrates another embodiment of the invention, where the slits and channels are not positioned in a bent section of the light guide. Here, the slits and channels 18 are used to bend just part 13 of the guided light 12 that is incident on them, whereas light 19 is not incident and thereby guided without being bent. The slits and channels 18 thereby perform the function of a beam splitter or divider. The ratio of bent light 13 to transmitted light 19 is only dependent of the area of the light guide core taken by the slits and channels 18. The beam splitter according to this embodiment thereby has the advantage over traditional beam splitters being, especially those provided by a semitransparent reflector, that the bend light 13 can be deflected in any chosen direction without affecting the ratio between deflected light 13 and transmitted light 19.

The embodiment of FIG. 6 illustrates just one alternative use and application of the present invention for other purposes than limiting losses in bent light guide sections. Numerous others are possible as may be contemplated by the person skilled in the art in the light of the present description.

The design of the slits and channels, meaning their shapes, positions and dimensions, may be adjusted to further improve the performance and decrease losses. First, it is noted that for TIR light guides, the sharpest possible bending without losses depends on the diameter of the waveguide core. In the present invention, this means that the smaller width a channel has, the smaller radius of curvature is possible while still performing TIR guiding without losses. It is therefore a preferred design parameter that the width D of a channel is smaller than its radius of curvature R i.e. R>D. It is an even more preferred design that the radius of curvature R is several times larger than the width of a channel, such as R•5D or R•15D. For R>>D the bending of light in the channel can be performed with no light losses. The optimal value depends on the refractive index of material and cladding, as well as the angular extent of the light source.

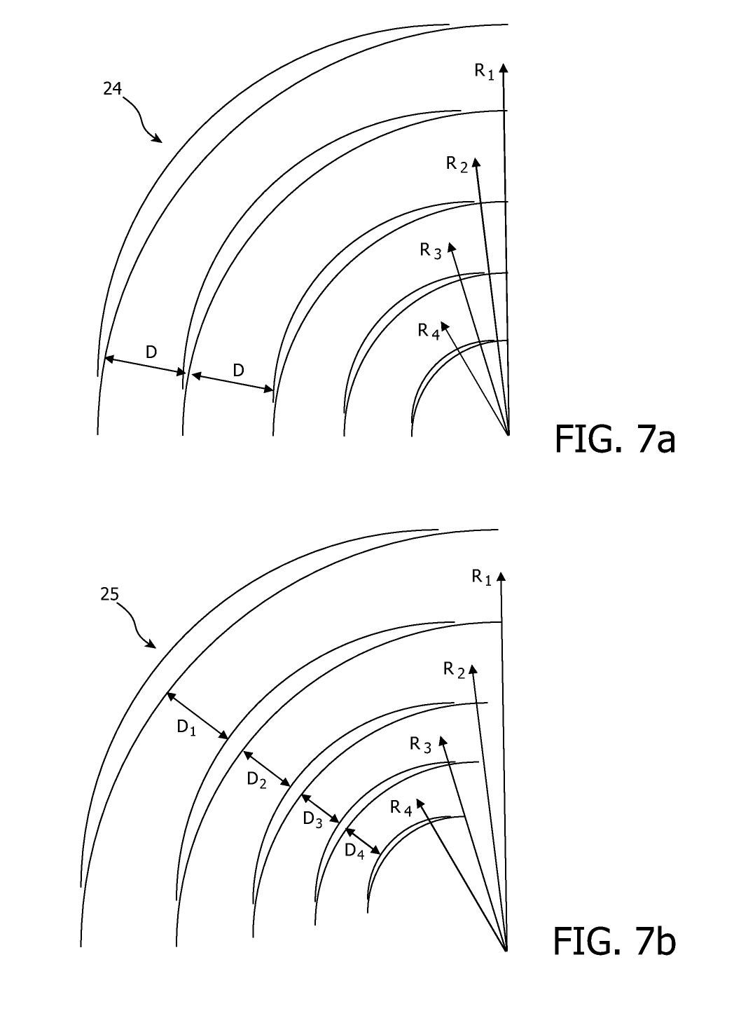

Two different layouts of slit and channels design are illustrated in FIGS. 7a and 7b. FIG. 7a shows a group of slits and channels 24 where the channel width or diameter D is the same for all channels, while curvature radius is different with R₁>R₂>R₃>R₄. With this design layout, the preferred design parameter is: Rₙ>D.

Similarly, FIG. 7b shows a group of slits and channels 25 where both the channel width or diameter Dₙ and curvature radius Rₙ are different for each channel so that D₁>D₂>D₃>D₄ and R₁>R₂>R₃>R₄. With this design layout, the preferred design parameter is: Rₙ>Dₙ. This design layout takes advantage of that channels positioned in the outer part of the bend have a larger curvature radius and can thereby be allowed to be wider without light guiding losses. This means that there can be larger distances between slits and thereby fewer slits. In the inner part of the bend, where radius' curvature is smaller, the slits are closer together to give narrower channels allowing for the sharper bending.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. A light guide (102) for bending guided light from a first direction (12) into a second direction (13), the light guide comprising:
a substrate forming a light guiding core of the light guide; and
one or more curved slits (9,10,11) formed in the light guiding core, each with a first end pointing towards said first direction and with a second end pointing towards said second direction, said one or more curved slits being arranged to delimit separate bent light guide channels (14,15,16,17) for guiding the light through the bent light guide channels by total internal reflection.

2. A light guide according to claim 1, wherein said bent light guide channels have a width adjusted to allow for bending of incident light from said first direction into said second direction with minimized light loss.

3. A light guide according to claim 2, wherein the width of each bent light guide channel is smaller than a bending radius of the bent light guide channel.

4. A light guide according to claim 1, wherein a section of the light guiding core is bent and said one or more slits are positioned in this bent section of the light guiding core.

5. A light guide according to claim 4, wherein a bending radius of the light guide core is larger than the widths of said bent light guide channels.

6. A light guide according to claim 1, wherein said one or more curved slits are filled by air.

7. A light guide according to claim 1, wherein said one or more curved slits are extending all the way through the thickness of the light guiding core.

8. A light guide according to claim 1, wherein said one or more curved slits have side facets that are normal to a plane of their curvature.

9. A device for bending light from a first direction into a second direction, the device comprising:
a light guide according to claim 1; and
a source of light arranged to couple light into said light guide.

10. A method for bending light from a first direction into a second direction, the method comprising the steps of:
providing a light guide; and
forming one or more curved slits into said light guide so that incident light is bent from said first direction into said second direction by total internal reflection in separate bent light guide channels delimited by said one or more curved slits.
